(19) United States
(12) Patent Application Publication
(10) Pub. No.: US 2003/0019303 A1
(43) Pub. Date: Jan. 30, 2003

(54) Shunt-free detection of a measured quantity on an accelerated part that is mounted on a radial bearing (wheel rim mounted on a wheel bearing

(76) Inventors: Klaus Dobler, Gerlingen (DE); Erich Zabler, Stutensee (DE); Anton Dukart, Gerlingen (DE); Martin Borsik, Holzgerlingen (DE); Dietmar Arnst, Kleinsachsenheim (DE); Gottfried Flik, Leonberg (DE); Hans-Peter Trah, Stuttgart (DE); Volker Imhof, Kornwestheim (DE)

Correspondence Address: Striker Striker & Stenby, 103 East Neck Road, Huntington, NY, 11743, US

(21) Appl. No.: 10/220,517

(22) PCT Filed: Dec. 20, 2001
(86) PCT No.: PCT/DE01/04846

(30) Foreign Application Priority Data
Jan. 19, 2001 (DE) 10102236.0

(51) Int. Cl. G01M 17/013; G01L 1/22

(52) U.S. Cl. 73/862.041; 73/862.045; 73/146

(57) ABSTRACT

An arrangement for detecting physical measurement variables, in particular force, torque, stress and/or acceleration, at a wheel bearing in a motor vehicle is proposed. This arrangement has a radial bearing (14, 15), a rotatable component (13, 24) interconnected with the radial bearing (14, 15), a sensing device (30) with which at least one physical measurement variable capable of being transferred from the rotatable component (13, 24) to the radial bearing (14, 15) can be detected, and a further device (16) interconnected with the radial bearing (14, 15) with which the rotational speed of the rotatable component (13, 24) can be influenced. It is further provided that the sensing device (30) and the further device (16) are situated at the radial bearing (14, 15) in relation to each other in such a manner that, when the rotational speed of the rotatable component (13, 24) is influenced by a force induced by the further device (16), a direct transfer of a portion of this force from the further device (16) to the sensing device (30) at least approximately does not take place. An object is therefore attained, namely that the physical measurement variable detected by the sensing device is induced at least approximately directly exclusively by the rotatable component (13, 24).

The invention concerns an arrangement for detecting physical measurement variables, in particular, force, torque, mechanical stress and/or acceleration, at a wheel bearing of a motor vehicle, according to the general class of the main claim.

### BACKGROUND OF THE INVENTION

It is becoming increasingly important in the field of automotive engineering to detect the states of motion of the motor vehicle, such as force, torque, stress or acceleration, transferred from the road to the motor vehicle via the tires or the wheel bearing as completely as possible and directly at the wheel bearing.

For this purpose, a sensor system in a rolling bearing has been proposed in the unpublished application DE 100 41 098.7, with which a detection of measurement variables, in particular force or torque, transferred to the rolling bearing takes place while a rotatable component carried in the rolling bearing moves. It has been proposed there, in particular, to integrate strain gauges in the rolling bearings, with which mechanical stress to which a bearing bushing of the rolling bearing is subjected can be detected in interaction with electronic components that are also integrated in the rolling bearing. The strain gauges are thereby located mainly in the region of the outer bearing bushing of the rolling bearing, and some are located in the region of the bearing flange as well, or in the region of force-transmitting parts of the fastening of the fixed bearing parts of the rolling bearing, and they are interconnected, e.g., in the form of measurement bridges or voltage divider circuits. It is otherwise made known in DE 100 41 098.7 to use piezoresistive film resistors in addition to or as an alternative to strain gauges.

Furthermore, a sensor system in a rolling bearing has also been proposed in the unpublished application DE 100 41 093.6, with which forces of expansion acting on the fixed bearing bushing of the rolling bearing can be detected, whereby the sensor elements used are strain-gauge resistors interconnected to form straingauge resistor measurement bridges.

With the sensor elements made known in the applications mentioned hereinabove, therefore, the detection of force, torque and expansion or compression that act on rolling bearings is known in principle.

The disadvantage of the known rolling bearings having an integrated sensing device is the ever-present redirection of forces via the braking system of the motor vehicle so that, during braking, the forces that are transferred from the road to the vehicle are no longer identical to the forces that occur in the wheel bearing and are measured there. In particular, such an undesired redirection of forces via the braking system results in a situation in which only a portion of the forces coming from the tire or the rim of the motor vehicle are transferred to the wheel bearing, and simultaneously, however, a portion of said forces is transferred to the braking system, so that the measurement variables detected by the sensor technology integrated in the wheel bearing have only limited meaning with regard for the forces actually acting on the tires of the vehicle, in particular when the brakes are actuated at the same time.

A wheel bearing for motor vehicles having a rolling bearing and a wheel flange interconnected with it for securing the wheel rim and the brake disc are made known in patent application DE 195 37 808 A1. The wheel bearing is thereby designed in such a fashion that it makes a simple and floating design of the brake disc possible while always ensuring sufficient ventilation of the brake disc. It has been proposed there, in particular, to provide the wheel flange with two regions displaced in parallel axially in relation to each other that alternate as viewed in the circumferential direction, and each of which has means for securing the brake disc or the wheel rim.

The object of the present invention was to perform as precise a measurement as possible of a physical measurement variable coming from a rotatable component, e.g., a wheel of a motor vehicle, and transferred to a radial bearing, e.g., a wheel bearing of a motor vehicle, whereby a transferred force, a transferred mechanical stress, torque and/or acceleration is relevant as a measurement variable. A further object of the invention was to make this measurement possible independent of the actuation of the brakes and, therefore, to always obtain a reliable statement about the total measurement variable coming from the rotatable component.

### ADVANTAGES OF THE INVENTION

In contrast to the related art, the arrangement according to the invention for detecting physical measurement variables has the advantage that, due to the relative arrangement of the sensing device for the actual detection of this measurement variable and the further device for influencing the rotational speed of the rotatable component in relation to each other, a redirection of forces from the rotatable component to the further device is prevented, so that the rotatable component transfers the respective physical measurement variable to be determined at least nearly exclusively to the radial bearing, where it can be determined continuously or as needed independently of the further device, e.g., when the braking system is actuated.

This ensures that, for example, force and/or torque, as the detected physical measurement variables, are induced at least approximately directly and exclusively by the rotatable component.

Advantageous further developments of the invention arise from the measures named in the dependent claims.

It is particularly advantageous when the radial bearing has a rotatable bearing bushing, whereby the sensing device is interconnected with the end face and the further device is interconnected with the side surface of the rotatable bearing bushing. Furthermore, as long as the rotatable component is interconnected with the end face of the rotatable bearing bushing, forces coming from the rotatable component, for example, act at least approximately exclusively on the region of the end face of the rotatable bearing bushing, where they are detected by the sensing device located there, while the further device for influencing the rotational speed of the rotatable component is interconnected exclusively with the side surface of the rotatable bearing bushing and, therefore, forces exerted at least approximately there on the bearing bushing cannot act directly on the end face having the sensing device.

An object attained in particular by means of this arrangement is that forces coming from the further device act initially on the rotatable component and not on the region of the sensing device, while forces coming from the rotatable component act initially on the region of the sensing device. That is, when the rotational speed of the rotatable component is influenced by a force induced by the further device, a direct transfer of a portion of this force from the further device to the sensing device at least approximately does not take place.

Furthermore, it is particularly advantageous when the rotatable bearing bushing is designed in the shape of a cup or a can, and when the further device, e.g., in the form of a brake disc, encloses the side surface of this can-shaped or cupshaped bearing bushing or is interconnected with it there.

Expansion-sensitive sensors such as strain gauges and/or strain-gauge resistor measurement bridge circuits-which are made known in the related art—are particularly suited for detecting the physical measurement variables transferred from the rotatable component to the radial bearing. These expansion-sensitive sensors are then advantageously located in the region of the end face of the rotatable bearing bushing.

With regard for a simple conditioning and further processing of the physical measurement variables detected by the sensing device, it is advantageous when said sensing device has an integrated conditioning unit already in the region of the end face of the rotatable bearing bushing or integrated in the bearing bushing, with which said conditioning unit the initially detected physical measurement variable can be amplified and, particularly advantageously, can be transferred from the rotating coordinate system of the rotatable bearing bushing into a coordinate system that is fixed, e.g., fixed in the vehicle.

The transfer of the detected and conditioned physical measurement variable from the sensing device to the vehicle then takes place either via a collector ring known per se or, particularly advantageously, in contactless or telemetric fashion.

### SUMMARY OF THE DRAWINGS

FIG. 1 illustrates the basic flow of force in a motor vehicle from the road to the chassis or the body according to the related art. FIG. 2 shows how this flow of force is modified according to the invention. FIG. 3 shows a principal sketch of a tire of a motor vehicle having a radial bearing and a brake disc secured to the radial bearing. FIG. 4 is a sectional drawing of a principal sketch of the rotatable bearing bushing of the wheel bearing with the brake disc interconnected with it and the sensing device applied to the end face.

### DESCRIPTION OF THE PREFERRED EMBODIMENTS

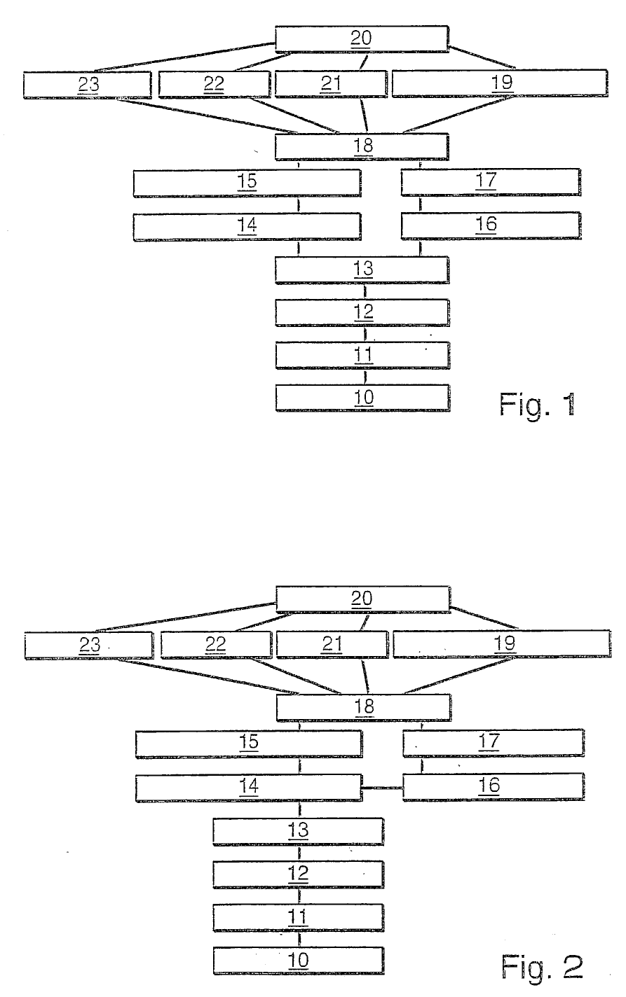

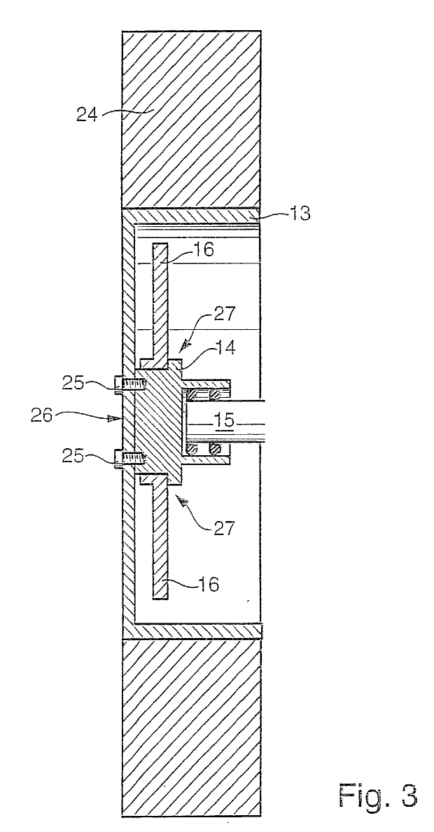

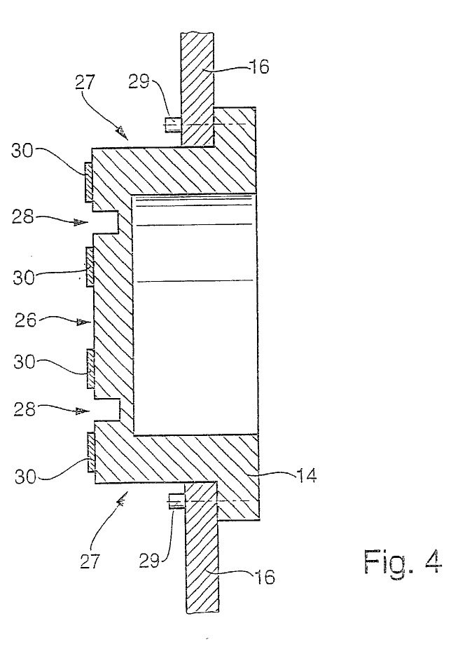

FIG. 1 illustrates the flow of force in a motor vehicle according to the related art, whereby a force or acceleration from a road 10 acting on the tires of the motor vehicle is first transferred from the road 10 to the tire contact area 11, from there to the side of the tire 12 and, from there, to the rim 13. The rim 13 is then interconnected, on the one hand, with a rotating wheel bearing part 14 or a rotatable bearing bushing 14. On the other hand, however, force is also redirected from the rim 13 to the brake disc 16 of the braking system of the motor vehicle, so that the total force acting on the rim 13 is not transferred from said rim to the rotatable part of the wheel bearing 14.

FIG. 1 further shows how the force acting on the rotatable wheel bearing part 14 first moves from said wheel bearing part to the stationary wheel bearing part 15 and, from there, it is transferred to the wheel carrier 18 while, at the same time, a portion of the force transferred from the rim 13 to the brake disc 16 is transferred from the brake disc 16 to the brake caliper 17 and, from there, to the wheel carrier 18 as well once more. From the wheel carrier 18, the acting forces are then transferred, on the one hand, to transverse control arms or longitudinal control arms 19, the suspension 21, the steering tie rod 22 and stabilizers 23, which then direct them further to the vehicle body 20.

An essential part of the present invention is the modification of the flow of force according to FIG. 1 by at least largely stopping the redirection of force from the rim 13 to the brake disc 16 in the first place, so that, at least approximately, the total force or acceleration acting on the rim 13 is transferred from the rim 13 to the rotating wheel bearing part 14, where it can be measured. This is illustrated with the aid of FIG. 2. The only difference between FIG. 2 and FIG. 1 is that, in FIG. 2, a direct transfer of force or flow of force from the rim 13 to the brake disc 16 does not take place, that is, the force, torque or mechanical stress coming from the rim 13 is first transferred in entirety to the rotating wheel bearing part 14 and only then from there to the stationary wheel bearing part 14 and the brake disc 16.

An exemplary embodiment of the invention is explained in greater detail with reference to FIG. 3, which shows a tire 24 of a motor vehicle, which said tire is located on a rim 13. This rim 13 is interconnected with the aid of screws 25 with a rotatable bearing bushing 14 of a radial bearing, e.g., a rolling bearing which, in actuality, is part of the wheel bearing of the motor vehicle.

In detail, the rotatable bearing bushing 14 in the example explained is designed at least approximately in the shape of a cup or a can, whereby the rim 13 is screwed to the end face 26 of the cup-shaped or can-shaped, rotatable bearing bushing 14 with the screws 25, while the brake disc 16 is screwed to the side surface 27, that is, the shell surface of the can-shaped, rotatable bearing bushing 14. It is further shown in FIG. 3 that the stationary part of the radial bearing 15 is interconnected with the vehicle axle.

It is to be emphasized here that the actual form of the rotatable bearing bushing 14 is subject to varied embodiments, and that a drive device can be provided just as well in place of the brake disc 16.

The rotatable bearing bushing 14 is preferably designed in such a fashion that the brake disc 16 can be connected to it reliably and easily, e.g., they can be screwed together. To this end, it is shown in FIG. 4 how the brake disc 16 is interconnected via screws 29 with the rotatable bearing bushing 14 on its side surface. It is further shown there that the connection of the rim 13 with the end face 26 of the rotatable bearing bushing 14 takes place, for example, via bores 28 applied therein.

In summary, it is therefore provided according to FIG. 3 and FIG. 4 to approximate the rotatable bearing bushing 14 in the first iteration as a can, over which first the brake disc 16 and then the wheel rim 13 are placed and each of which is interconnected with said bearing bushing.

Since, according to FIG. 3 and FIG. 4, the brake disc 16 is interconnected only with the cylindrical side surface 27 of the can-shaped, rotatable bearing bushing 14, a force or mechanical stress coming from the brake disc 16 does not result, at least approximately, in a modification of the stress state of the end face 26 of the rotatable bearing bushing 14, so that the end face 26 approximately remains unaffected by an instantaneous braking torque or by forces coming from the braking system. An object is therefore attained, namely that the rim 13 is housed only by such regions of the rotatable bearing bushing 14, the elastic stress state of which is not dependent on the actuation of the brakes or the force presently being exerted by the brake disc 16 on the wheel bearing, so that a direct transfer of force between rim 13 and brake disc 16 does not take place.

As far as that goes, mechanical stress or force or torque occurring in the region of the end face 26 of the rotatable bearing bushing 14 only results from variables that are transferred directly from the rim 13 to the wheel bearing or the rotatable bearing bushing 14, and, therefore, they can always be detected there reliably and in entirety, for example, with the aid of standard strain gauges 30.

For the rest, strain-gauge resistor measurement bridge circuits can also be provided in addition to strain gauges 30 in the region of the end face 26, whereby, in a preferred embodiment of the invention, a conditioning unit—not shown in FIGS. 3 and 4—is also located or integrated there as well, with which the respective physical measurement variable is amplified, on the one hand, by the sensing device located on the end face 26, that is, in the actuality, in the strain gauges 30 and, particularly advantageously, on the other hand, [the physical measurement variable] is transferred simultaneously from the rotating coordinate system of the rotatable bearing bushing 14 into a coordinate system that is fixed and, in particular, is fixed in the vehicle.

With regard for the actual embodiment of the strain gauges 30, reference is made, for example, to applications DE 100 41 093.6 or DE 100 41 098.7, where such arrangements and the structure and function of strain gauges is described in detail.

In the sectional drawing through the rotatable bearing bushing 14 according to FIG. 4, it is obvious that strain gauges 30 are also located on the surface of the end face 26 of the rotatable bearing bushing 14, with which said strain gauges mechanical stress, force, torque or acceleration transferred from the rim 13 to this end face 26 can be detected.

Finally, it is always provided that the strain gauges 30 or the conditioning unit are electrically interconnected with a not shown transfer component, e.g., a collector ring, so that, via this transfer component, the physical measurement variable detected by the strain gauges 30 or the physical measurement variable transmitted by the strain gauges 30 to the conditioning unit and conditioned there can be transmitted to a processing unit that is fixed and, in particular, is fixed in the vehicle.

A particularly advantageous embodiment in this context provides that the physical measurement variable detected by the strain gauges 30—after conditioning, if necessary—is transmitted not to the collector ring but, in contactless or telemetric fashion, to the processing unit that is fixed in the vehicle.

It is preferably to be provided that a not shown microcontroller is integrated on the rotatable bearing bushing 14 to convert the detected physical measurement variable from the rotating coordinate system of the rotatable bearing bushing 14 into a coordinate system that is fixed in the vehicle.

The conversion from the rotating coordinate system into a coordinate system fixed in the vehicle directly at the rotatable bearing bushing 14 results in the advantage that the detection of the time and the exact angular position when and where the respective physical measurement variable was detected on the end face 27 of the rotatable bearing bushing 14 can be eliminated.

What is claimed is:

1. An arrangement for detecting physical measurement variables, in particular force, stress, torque and/or acceleration, at a wheel bearing of a motor vehicle, having a radial bearing, a rotatable component interconnected with the radial bearing, a sensing device with which at least one physical measurement variable capable of being transferred from the rotatable component to the radial bearing can be detected, and a further device interconnected with the radial bearing with which the rotational speed of the rotatable component can be influenced,
wherein the sensing device and the further device are situated at the radial bearing (14, 15) in relation to each other in such a manner that, when the rotational speed of the rotatable component (13, 24) is influenced by a force induced by the further device, a direct transfer of at least a portion of this force from the further device to the sensing device at least approximately does not take place.

2. The arrangement according to claim 1,
wherein the sensing device and the further device are situated at the radial bearing (14, 15) in relation to each other in such a manner that, even when the rotational speed of the rotatable component (13, 24) is influenced by the force induced by the further device, the physical measurement variable detected by the sensing device is induced at least approximately directly exclusively by the rotatable component (13, 24).

3. The arrangement according to claim 1 or 2,
wherein a rotatable bearing bushing (14) interconnected with the rotatable component (13, 24) is provided with an end face (26) and a side surface (27), whereby the sensing device is interconnected with the end face (26), and the further device is interconnected with the side surface (27) of the rotatable bearing bushing (14).

4. The arrangement according to claim 3,
wherein the rotatable bearing bushing (14) is designed at least approximately in the shape of a cup or a can, whereby the end face (26) forms the bottom and the side surface (27) forms—at least in certain regions—the shell of the cup or the can.

5. The arrangement according to one of the preceding claims,
wherein the sensing device is situated in such a fashion that it detects at least largely exclusively the force, torque and/or acceleration exerted directly by the rotatable component (13, 24) on the end face (26) of the moveable bearing bushing (14), and that the further device is situated in such a fashion that, when the rotational speed of the rotatable component (13, 24) is being influenced, it exerts force directly at least largely exclusively on the side surface (27) of the moveable bearing bushing (14).

6. The arrangement according to one of the preceding claims,
wherein the further device has a brake disc (16) that surrounds the side surface (27) of the moveable bearing bushing (14) and is interconnected with it in certain regions.

7. The arrangement according to one of the preceding claims,
wherein mechanical stress and/or rotation or compression induced by the rotatable component (13, 24) can be detected with the sensing device in the end face (26) of the rotatable bearing bushing (14).

8. The arrangement according to claim 7,
wherein the sensing device has expansion-sensitive sensors such as wire strain gauges (30) and/or strain-gauge resistor measurement bridge circuits.

9. The arrangement according to one of the preceding claims,
wherein the rotatable component (13, 24) is interconnected—in particular, screwed together—with the end face (26) of the rotatable bearing bushing (14).

10. The arrangement according to one of the preceding claims,
wherein the sensing device has a conditioning unit that is integrated or situated, in particular, in the region of the end face (26) of the rotatable bearing bushing (14), with which the detected physical measurement variable can be amplified and/or transferred from the rotating coordinate system of the rotatable bearing bushing (14) into a coordinate system that is fixed and, in particular, is fixed in the vehicle.

11. The arrangement according to one of the preceding claims,
wherein a transfer component, in particular a collector ring, is provided, with which the physical measurement variable detected by the sensing device or conditioned by the conditioning unit can be transmitted to a processing unit that is fixed and, in particular, is fixed in the vehicle.

12. The arrangement according to one of the preceding claims,
wherein, with the transfer component, the detected or conditioned physical measurement variable can be transferred from the sensing device to the processing unit in contactless, in particular, telemetric, fashion.

13. The arrangement according to one of the preceding claims,
wherein the rotatable component (13, 24) is a rim (13) outfitted with a tire (24) of a motor vehicle, and the radial bearing (14,15) is a wheel bearing of a motor vehicle.
